(19) United States
(12) Patent Application Publication
(10) Pub. No.: US 2017/0322117 A1
(43) Pub. Date: Nov. 9, 2017

(54) SYSTEM FOR EVALUATING THE CONDITION OF A TIRE, EQUIPPED WITH A DEVICE FOR DETECTING THE DIRECTION OF TRAVEL

(71) Applicants: COMPAGNIE GENERALE DES ETABLISSEMENTS MICHELIN, CLERMONT-FERRAND (FR); MICHELIN RECHERCHE ET TECHNIQUE S.A., Granges-Paccot (CH)

(72) Inventors: THOMAS LEDOUX, Clermont-Ferrand (FR); DENIS MARTIN, Clermont-Ferrand (FR); GUILLAUME HEREDIA, Clermont-Ferrand (FR); ALEXANDRE PERNOT, Clermont-Ferrand (FR)

(21) Appl. No.: 15/535,210

(22) PCT Filed: Dec. 11, 2015
(86) PCT No.: PCT/EP2015/079460

§ 371 Date: Jun. 12, 2017

(30) Foreign Application Priority Data
Dec. 17, 2014 (FR) 1462593

(51) Int. Cl. G01M 17/02; G01P 13/02

(52) U.S. Cl. CPC G01M 17/02; G01P 13/02

(57) ABSTRACT

A system for evaluating a state of a tire on a vehicle is provided. The system includes a housing, first and second sensors, and control electronics. The housing is located on a ground surface. The first sensor is installed in the housing and measures a first characteristic of a tire passing over the housing. The second sensor is installed in the housing and measures a second characteristic of a tire passing over the housing. The first and the second sensors are positioned such that instants of passage of the vehicle rolling over the housing at positionings of the sensors are distinct from each other. The control electronics determines a direction of rolling of the vehicle over the housing based on each of the positionings of the sensors in the housing and on the instants of passage of the vehicle over the sensors.

### TECHNICAL FIELD

The present invention relates to a system for evaluating the state of a tire. More precisely, the invention relates to such a system furnished with a device for detecting the direction of rolling of a vehicle over this evaluation system.

Within the meaning of the present invention, a system for evaluating the state of a tire is for example, but not limitingly, a system making it possible to detect the wear of a tire, a system making it possible to detect the pressure of a tire, or by extension a system making it possible to measure the speed of a tire.

Thus, the invention also relates to a method for detecting the direction of rolling of a tire over a system according to the invention. It also relates to a method for detecting the speed of passage of a vehicle over a system according to the invention.

Numerous systems allowing the diagnosis of a vehicle are known. In respect of wear, it is thus possible to cite wear telltales present on tires, or manual devices for measuring the height of rubber remaining on a tire.

Concerning pressure measurement, it is possible to cite systems installed directly on the wheels of vehicles, which determine the pressure by means of a pressure sensor and which thereafter dispatch the information by radiofrequency to the vehicle's central electronics; off-board systems allowing the measurement of contact pressure of the tires at the ground level, or else manual manometers.

The present invention is aimed at providing a system, notably usable by vehicle fleet managers, which can be included in a more general system for diagnosis of the state of a vehicle and of its tires. However, none of the known systems currently allows cross-checking of various pieces of information relating to the vehicle and its tires.

A measurement system comprising a running bench intended to accommodate the passage of a vehicle is known from Document US 2009/0000370. It has however been found that, for large gauge vehicles, it was sometimes necessary to use two distinct running benches for each of the sides of the vehicles, and that such a system did not make it possible to identify, during a measurement, the side of the vehicle concerned in the said measurement.

The present invention is therefore aimed at remedying this drawback by proposing an improvement of existing vehicle diagnosis systems.

### BRIEF DESCRIPTION OF THE INVENTION

Thus, the invention proposes a system for evaluating the state of a tire, the system comprising a first housing laid on the ground, the said system comprising
a first sensor, installed in the housing, and intended to measure a first characteristic of a tire passing over the housing,
a second sensor, installed in the housing, and intended to measure a second characteristic of a tire passing over the housing
the first and the second sensors being positioned in such a way that the instants of passage of a vehicle rolling over the housing at the level of each of the sensors are distinct,
and the system furthermore comprising control electronics comprising means for determining a direction of rolling of the vehicle over the housing as a function of the positionings of each of the sensors in the housing and of the instants of passage of a vehicle over each of the sensors.

Such a system thus makes it possible to measure various characteristics of a tire in a single pass, and also makes it possible to detect the direction of rolling of the vehicle over the system during this pass.

In an advantageous embodiment, the first and second sensors are positioned in the housing in such a way that the projection of their position on the plane upper face of the housing defines a line non-orthogonal to the direction of rolling of a vehicle over the housing.

In an advantageous embodiment, the first and/or the second sensor are included in the group comprising: an eddy-current-based wear sensor, a variable-reluctance wear sensor, a laser-based optical wear sensor, a local pressure or load sensor.

In an advantageous embodiment, the system furthermore comprises a tire presence detection device installed in the housing. In a preferential manner, this presence detection device uses a single input on the system control electronics.

In an advantageous embodiment the presence detection device comprises a sensitive element included in the group comprising: an accelerometer or any type of sensor sensitive to vibrations or to shocks, a magnetometer or any type of sensor sensitive to terrestrial magnetic field variation, a resistance wire extensometer, also called strain gauges or deformation gauges, a piezoelectric buzzer or any system using a piezoelectric material or a composite such as a piezo-electrical paint.

Alternatively, the tire presence detection device may consist of a leaktight cavity accommodating a fluid and of a pressure sensor installed so as to measure the pressure of the fluid in this cavity. The arrival of a tire over the housing causes an increase in pressure of the fluid in the cavity, detected by the pressure sensor. This signal can thereafter be used as indicator of the presence of a vehicle over the housing. In another example, it is possible to use a mechanical contact detector, implementing a flexible plate. This contact detector is positioned at an end of the cavity, and subjected to a motion of the fluid should the pressure in the cavity increase. This detector closes electrically when a vehicle is present over the housing.

In an advantageous embodiment, the system comprises a first group of sensors of the same type as the first sensor, and a second group of sensors of the same type as the second sensor, the sensors of the first group being positioned in such a way that their orthogonal projections on the plane upper surface of the housing form a first line, and the sensors of the second group being positioned in such a way that their orthogonal projections on the plane upper surface of the housing form a second line, and the first and second lines being distinct, and oriented in a direction not parallel to the direction of rolling of a vehicle over the housing. Preferentially, the two lines are orthogonal to the direction of rolling of a vehicle over the housing.

The use of a number of higher sensors makes it possible to guarantee that the measurements are performed during the passage of a vehicle over a housing, this being so whatever the size of the tires of the vehicle. Indeed, by positioning several sensors over the width of the housing, it is guaranteed that any tire passing over the housing will pass at least above a sensor of the first group and above a sensor of the second group. The number of sensors will therefore advantageously be chosen as a function of the dimensions of the housing and of the dimensions of the envisaged tires.

These sensors will preferably be positioned quincuncially. Quincunx is understood to mean a position according to which the orthogonal projections of the sensors of the first group are regularly distributed over a first line, the orthogonal projections of the sensors of the second group are regularly distributed over a second line, and the elements of the second line are offset by a half-spacing with respect to the elements of the first line, a spacing corresponding to the gap between two elements of the first line. This quincuncial positioning assists the effectiveness of the measurement system such as explained in the previous paragraph.

In an advantageous embodiment, the system comprises a second housing identical to the first, the first and second housings being positioned in such a way that during the passage of a vehicle, the tires situated on a first side of the vehicle roll over the first housing, and the tires situated on a second side of the vehicle roll over the second housing.

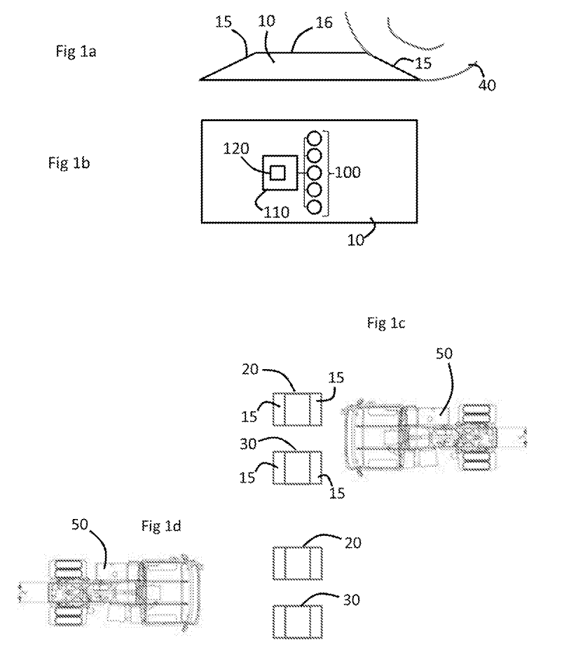

The use of such a system furnished with two housings is particularly advantageous for the evaluation of tires installed on large gauge vehicles, for example heavy goods vehicles. This typical case will subsequently be described in detail with the aid of the figures, notably FIGS. 1c and 1d.

The invention also relates to a method for determining the direction of rolling of a vehicle over a system for evaluating the state of a tire according to the invention. This method comprises the following steps:
A step of detecting the crossing of a first voltage threshold by the first sensor,
A step of detecting the crossing of a second voltage threshold by the second sensor,
A step of determining the direction of rolling as a function of the positioning of the two sensors and of the chronology of the two previously detected crossings.

This method finds a particularly advantageous application in the case, mentioned previously, of an evaluation system comprising two housings. This case of application will subsequently be detailed with the aid of figures.

The invention also relates to a method for measuring the speed of a tire rolling an evaluation system according to the invention. This method comprises the following steps:
a step of detecting the crossing of a first voltage threshold by the first sensor,
a step of detecting the crossing of a second voltage threshold by the second sensor, and
a step of calculating the speed of the vehicle by dividing the distance between the orthogonal projections of the positions of each of the sensors on the plane upper face of the housing by the time elapsed between the two previously detected crossings.

In an advantageous embodiment, the distance between the orthogonal projections is recorded in a memory linked to the system control electronics.

In another advantageous embodiment, the system according to the invention is furnished with radiofrequency communication means allowing the transmission of the measured data to a remote server. In this case, the distance between the orthogonal projections can be recorded in a database installed on a remote server, and the calculation of the speed can be performed by calculation means associated with the said database.

### DESCRIPTION OF THE BEST EMBODIMENT OF THE INVENTION

Other advantages and embodiments of the invention will become apparent with the nonlimiting detailed description of the figures in which:

FIGS. 1a, 1b, 1c and 1d show an evaluation system exhibiting the drawbacks of the prior art, and

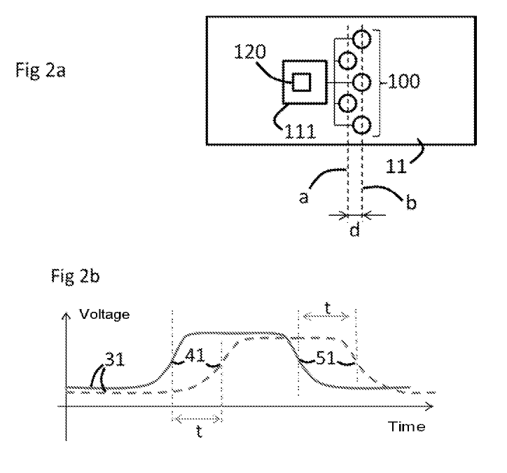

FIGS. 2a and 2b show an evaluation system according to the invention.

FIGS. 1c and 1d show an evaluation system according to the prior art, comprising two housings 20 and 30. These two, identical, housings are positioned in such a way that when a vehicle passes over the system, the tires installed on a first side of the vehicle roll over one of the two housings, and the tires installed on the other side of the vehicle roll over the other housing:

Each of the housings is identical to the housing 10 shown in FIGS. 1a and 1b. Such a housing consists of two access ramps 15 and of a horizontal wear measurement zone 16 situated between the two access ramps 15.

It furthermore comprises:
a line of sensors 100, for example wear sensors, positioned along a line transverse to the direction of the rolling of the vehicle arriving on the housing 10. These wear measurement sensors may equally well be variable-reluctance sensors, eddy-current-based sensors or laser-based optical sensors.
Of processing electronics 110 to which the measurement sensors 100 are connected. In this example, the processing electronics 110 also contains an RFID reader allowing the reading of RFID chips integrated into the tires or glued on the vehicle whose tire wear is measured, as well as radio frequency transmission means allowing the dispatching of the data into a remote database.

Furthermore, the electronics 110 is equipped with a tire 40 presence detection device 120 making it possible to activate the measurement system solely at the moment or a tire 40 presents itself over the system. In the case set forth in this example, the tire presence detection device 120 consists of a single sensor sensitive, for example, to the vibrations or shock waves propagating in the structure of the housing 10 when a tire 40 arrives over the said housing.

In a variant embodiment of the housings 20 and 30, this sensor for detecting presence of a tire is a sensor sensitive to the variation of the terrestrial magnetic field when a vehicle arrives over the measurement system.

In any event, in the example of FIGS. 1a, 1b, 1c and 1d, the tire presence detection device 120 does not give information making it possible to determine the direction of rolling of the tire which arrives over the measurement system.

Thus, in the case of FIG. 1c, the vehicle 50 arrives over the two housings 20 and 30 from the right. In this case, the tires situated on the left side of the vehicle 50 will be seen by the housing 30 and the tires situated on the right side of the vehicle 50 will be seen by the housing 20.

Conversely, in the case of FIG. 1d, the vehicle 50 arrives over the two housings 20 and 30 from the left. In this case, the tires situated on the left side of the vehicle 50 will be seen by the housing 20 and the tires situated on the right side of the vehicle 50 will be seen by the housing 30.

In this case, the system not knowing the direction of rolling of the vehicle, it will not be able to determine to which side of the vehicle the tires measured by the two housings 20 and 30 belong. It will not therefore be possible to specify the side of the vehicle on which a possible maintenance operation should be programmed, for example, because of overly significant wear.

FIG. 2a shows an embodiment of the invention making it possible to remedy this problem. In this example, the transverse line of sensors 100, for example wear sensors, is split so that two transverse lines a and b are created. These two lines a and b also consist of sensor for measuring wear 100. In this example, the total number of sensors disposed along these two lines a and b is identical to the number of sensors which were disposed along the single transverse sensor line 100 set forth in the case of FIG. 1b, and the sensors are disposed quincuncially.

If it is imagined that the housings 20 and 30 of FIG. 1d are compliant embodiment of the invention described in FIG. 2a, if a vehicle presents itself from the right over the measurement system 11 thus created, the measurement sensors 100 situated on the line b will be able to begin carrying out a measurement before the sensors situated on the line a.

Conversely, if a vehicle presents itself from the left of the measurement system 11, the measurement sensors 100 situated on the line a will be able to begin carrying out a measurement before the sensors situated on the line b.

Furthermore, in this example, the processing electronics 111 comprises means for determining the time elapsed between the start of the measurement on either of the two lines of sensors and the start of the measurement on the other line of sensors.

The distance between the line a and the line b being known, it is also possible to measure the speed of the tire by using the time elapsed between the start of the measurement by the line b and the start of the measurement by the line a. If appropriate, it suffices to apply the formula:

V=d/t

in which V is the speed of the tire whose wear is measured, d is the distance between the two lines of sensors a and b and t is the time elapsed between the start of the measurement by either of the lines of sensors and the start of the measurement by the other line of sensors.

Alternatively, it is possible to determine the time t by measuring the time elapsed between the end of the measurement by one of the lines of sensors and the end of the measurement by the other line of sensors.

FIG. 2b shows the evolution of the output voltage 31 of two wear measurement sensors 100, one belonging to the sensor line a and the other to the sensor line b of a system according to the invention. The solid-line output signal is that of a sensor situated on the line a and the dashed output signal and that of a sensor situated on the line b. Preferentially, the two output signals 31 arise from two adjacent sensors. Adjacent sensors is understood to mean a sensor situated on a first line and one of the two closest sensors situated on the other line.

The electronics 111 is furnished with threshold-based electronics making it possible to detect the crossing, by the signal, of a voltage threshold labelled at the positions 41 and 51 on the signals 31. It is therefore possible to label the direction of rolling by observing the order in which the output signals of adjacent sensors 100 each situated on two different lines cross the threshold 41.

Alternatively, it is possible to use the threshold 51, corresponding to the moment at which the tire whose wear is measured leaves the measurement zone situated on the housing 11, to reach the same conclusion.

In the case of FIG. 2b, it is therefore possible to conclude that these signals have been obtained with a vehicle arriving from the left over the system for measuring the wear 11, since the sensor of line a is activated before the sensor situated on line b.

Furthermore, the time t elapsed between the passage of the solid-line signal through the threshold 41, or 51, and the passage of the dashed signal through the same threshold 41, or 51, corresponds to the time required for the tire to pass from sensor line a to sensor line b.

As explained previously, the gap between the two lines a and b being known, it is this time t which will have to be used to measure the speed of passage of the vehicle over the system.

1-15. (canceled)

16. A system for evaluating a state of a tire on a vehicle, the system comprising:
a first housing positioned on a ground surface;
a first sensor installed in the first housing and arranged to measure a first characteristic of the tire passing over the first housing, and a second sensor installed in the first housing and arranged to measure a second characteristic of the tire passing over the housing, wherein the first and the second sensors are positioned such that instants of passage of the vehicle rolling over the first housing at positionings of the first and second sensors are distinct from each other; and
a controller that determines a direction of rolling of the vehicle over the first housing based on the positionings of the first and second sensors in the first housing and on the instants of passage of the vehicle over the first and second sensors.

17. The system according to claim 16, wherein the first and second sensors are positioned in the first housing such that a projection of the positionings on a planar upper face of the first housing defines a line non-orthogonal to the direction of rolling of the vehicle over the first housing.

18. The system according to claim 16, wherein at least one of the first and second sensors is one of: an eddy-current-based wear sensor, a variable-reluctance wear sensor, a laser-based optical wear sensor, a pressure sensor, and a local load sensor.

19. The system according to claim 16, further comprising a tire presence detector installed in the first housing.

20. The system according to claim 19, wherein the tire presence detector uses a single input on the controller.

21. The system according to claim 19, wherein the tire presence detector includes a sensitive element that is one of: an accelerometer, a sensor sensitive to vibrations or shocks, a magnetometer, a sensor sensitive to terrestrial magnetic-field variations, a resistance wire extensometer, a piezoelectric buzzer, and a device that utilizes a piezoelectric material.

22. The system according to claim 19, wherein the tire presence detector includes a cavity filled with a fluid, a pressure sensor, and a mechanical contact detector on a flexible plate.

23. The system according to claim 16, further comprising:
a first group of sensors of a same type as the first sensor, and
a second group of sensors of a same type as the second sensor,
wherein the sensors of the first group are positioned such that orthogonal projections of the sensors of the first group on a planar upper surface of the first housing form a first line,
wherein the sensors of the second group are positioned such that orthogonal projections on the planar upper surface of the first housing form a second line, and
wherein the first and second lines are distinct from each other and oriented in a direction not parallel to the direction of rolling of the vehicle over the first housing.

24. The system according to claim 23, wherein the orientation of the first and second lines is orthogonal to the direction of rolling of the vehicle over the first housing.

25. The system according to claim 23, in which the sensors of the first and second groups are positioned quincuncially.

26. The system according to claim 16, further comprising a second housing identical to the first housing, wherein the first and second housings are positioned such that during passage of the vehicle, tires situated on a first side of the vehicle roll over the first housing and tires situated on a second side of the vehicle roll over the second housing.

27. A method for determining a direction of rolling of a vehicle over a tire-state evaluation system that includes a first housing positioned on a ground surface, a first sensor installed in the first housing and arranged to measure a first characteristic of the tire passing over the first housing, a second sensor installed in the first housing and arranged to measure a second characteristic of the tire passing over the housing, wherein the first and the second sensors are positioned such that instants of passage of the vehicle rolling over the first housing at positionings of the first and second sensors are distinct from each other, and a controller that determines a direction of rolling of the vehicle over the first housing based on the positionings of the first and second sensors in the first housing and on the instants of passage of the vehicle over the first and second sensors, the method comprising steps of:
detecting a crossing of a first voltage threshold by the first sensor;
detecting a crossing of a second voltage threshold by the second sensor; and
determining the direction of rolling of the vehicle based on the positionings of the first and second sensors and on a chronology of the crossing detected by the first sensor and the crossing detected by the second sensor.

28. A method for determining a direction of rolling of a vehicle over a tire-state evaluation system that includes a first housing positioned on a ground surface, a first sensor installed in the first housing and arranged to measure a first characteristic of the tire passing over the first housing, a second sensor installed in the first housing and arranged to measure a second characteristic of the tire passing over the housing, wherein the first and the second sensors are positioned such that instants of passage of the vehicle rolling over the first housing at positionings of the first and second sensors are distinct from each other, and a controller that determines a direction of rolling of the vehicle over the first housing based on the positionings of the first and second sensors in the first housing and on the instants of passage of the vehicle over the first and second sensors, the method comprising steps of:
detecting a crossing of a first voltage threshold by the first sensor;
detecting a crossing of a second voltage threshold by the second sensor; and
calculating a speed of the vehicle by dividing a distance between orthogonal projections of the positionings of the first and second sensors on a planar upper face of the first housing by an elapsed time between the crossing detected by the first sensor and the crossing detected by the second sensor.

29. The method according to claim 28, further comprising a step of recording the distance between the orthogonal projections in a memory linked to the controller.

30. The method according to claim 28, further comprising a step of recording the distance between the orthogonal projections in a database installed on a remote server, wherein the step of calculating the speed is carried out by a calculator associated with the database.
